(19) United States
(12) Patent Application Publication
(10) Pub. No.: US 2010/0267346 A1
(43) Pub. Date: Oct. 21, 2010

(54) METHODS AND APPARATUS FOR CONTROL SIGNALING IN A COMMUNICATION SYSTEM

(75) Inventors: Ming-Chang Tsai, San Diego, CA (US); Yibo Jiang, San Diego, CA (US); Sharad D. Sambhwani, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/427,146

(22) Filed: Apr. 21, 2009

(51) Int. Cl. H04B 7/00

(52) U.S. Cl. 455/69

(57) ABSTRACT

Methods and apparatus for control signaling in a communication system using continuous valued measurement and feedback are disclosed. The control signaling utilizes delta-sigma modulation where a measured phase or amplitude of a received signal is used to determine a difference signal by subtracting a previously quantized integrated difference signal from the current measurement signal, and then integrating the difference signal. The integrated difference signal is quantized and transmitted to the device originating the received signal as feedback control signaling. The device originating the received signal may then filter the control signaling to obtain the desired control information used to adjust or control the transmission of the signal transmitted by the device. By utilizing delta-sigma modulation, a greater degree of control signaling precision is achieved when controlling variables such as phase or amplitude of the transmitted signals, thereby achieving improved communication system performance.

### BACKGROUND

1. Field

The present disclosure relates generally to methods and apparatus for control signaling in a communication system, and more specifically to utilizing delta-sigma modulation for control signaling in communication systems having continuous valued measurement and feedback, such as in closed-loop transmit diversity (CL-TD) systems.

2. Background

In many mobile wireless communication systems, system operation uses significant control signaling in both uplink (i.e., a mobile device to a base station) and downlink (i.e., base station to mobile devices) directions. Many of the control signals are continuous-valued in nature, such as phase and power measurements for closed loop transmit diversity (CL-TD) as an example. Effectiveness of such control signaling, however, is often times limited more by control signaling granularity depending on Over the Air (OTA) resource allocation per channel use, than by allowed rate of such channel use. For example, in a UMTS system control channel allocation is one or two bits per channel at a rate of 1500 Hz for just phase adjustment. Assuming 2 bits per channel (i.e., four possible values), phase adjustment via the control signaling in a 360° range can only be quantized into four values at 90° resolution, for example, which also implies a quite significant ±45° error. Thus, such fixed quantization schemes in control signaling imply a fixed amount of error, which becomes particularly acute in situations when a communication device is positioned where maximum phase error occurs.

In general, performance degradation due to quantization depends on types of control signaling in CL-TD systems, each of which has specific cost associated for deviation of quantized signal from continuous-valued signal as well as for fast transition among quantization levels. One method of enhancing the performance of control signaling is by allowing finer resolution with direct quantization, such as with 3 or 4 bits. Such enhancement, however, is at a cost of scarce control channel resources or OTA resources.

Performance enhancement is also possible if the feedback rate can be lowered with an aggregation of multiple channel uses for finer quantization granularity. This enhancement is at the cost of latency, however, and thus limits the effectiveness of closed-loop control, which may or may not be acceptable over fast changing channel conditions. Another possible approach to enhancement is by applying delta modulation for more efficient utilization of the same given OTA resource allocation. This approach, however, involves a tradeoff of quantization step size for conflicting requirements between granularity and slope overload.

### SUMMARY

According to an aspect, a method for control signaling is disclosed. The method includes: receiving a communication signal, and measuring at least one of a phase and amplitude of the received communication signal to derive a current measurement signal. The method further includes determining a difference signal by subtracting a previously quantized integrated difference signal from the current measurement signal, integrating the difference signal, and then quantizing the integrated difference signal. Finally, the quantized integrated difference signal is transmitted as part of control signaling to a communication device.

According to another aspect, a method for control signaling is disclosed that includes receiving control signaling including control information from a communication device that is a quantized signal formed using delta-sigma modulation. The method further includes filtering the control signaling to obtain the control information, and controlling one of phase and amplitude for a transmitter portion of a wireless device based on the control information.

According to yet another aspect, an apparatus for control signaling is disclosed. The apparatus includes a receive unit configured to receive a communication signal. Also included are a measurement unit configured to measure at least one of a phase and amplitude of the received communication signal to derive a current measurement signal, and an additive calculation unit configured to determine a difference signal by subtracting a previously quantized integrated difference signal from the current measurement signal. The apparatus also includes an integrator configured to integrate the difference signal, a quantization unit configured to quantize the integrated difference signal, and a transmitter unit configured to transmit the quantized integrated difference signal as part of control signaling to a communication device.

According to still a further aspect, an apparatus for control signaling is disclosed. The apparatus includes a receiver unit configured to receive control signaling including control information from a communication device that is a quantized signal formed using delta-sigma modulation. The apparatus also includes a band limiting unit configured to filter the control signaling to obtain the control information, and a control unit configured to control one of phase and amplitude for a transmitter portion of a wireless device based on the control information.

According to another aspect, an apparatus for control signaling is disclosed that includes means for receiving a communication signal, and means for measuring at least one of a phase and amplitude of the received communication signal to derive a current measurement signal. The apparatus also includes means for determining a difference signal by subtracting a previously quantized integrated difference signal from the current measurement signal, means for integrating the difference signal, and means for quantizing the integrated difference signal. Finally, the apparatus includes means for transmitting the quantized integrated difference signal as part of control signaling to a communication device.

According to yet a further aspect, an apparatus for control signaling is disclosed having means for receiving control signaling including control information from a communication device that is a quantized signal formed using delta-sigma modulation. The apparatus also includes means for filtering the control signaling to obtain the control information, and means for controlling one of phase and amplitude for a transmitter portion of a wireless device based on the control information.

In still another aspect, a computer program product comprising a computer-readable medium is disclosed. The medium includes code for causing a computer to receive a communication signal, code for causing a computer to measure at least one of a phase and amplitude of the received communication signal to derive a current measurement signal, and code for causing a computer to determine a difference signal by subtracting a previously quantized integrated difference signal from the current measurement signal. The medium also includes code for causing a computer to integrate the difference signal, and code for causing a computer to quantize the integrated difference signal; and code for causing a computer to transmit the quantized integrated difference signal as part of control signaling to a communication device.

In still one more aspect, a computer program product comprising a computer-readable medium is disclosed. The medium includes code for causing a computer to receive control signaling including control information from a communication device that is a quantized signal formed using delta-sigma modulation, and code for causing a computer to filter the control signaling to obtain the control information. The medium further includes code for causing a computer to control one of phase and amplitude for a transmitter portion of a wireless device based on the control information.

### BRIEF DESCRIPTION OF THE DRAWINGS

FIG. 1 illustrates a multiple access wireless communication system according to an example.

FIG. 2 is a block diagram of an exemplary architecture for a system for CL-TD phase control using feedback, delta-sigma modulation, and control signaling.

FIG. 3 is a block diagram of another exemplary architecture for a system for CL-TD phase control using feedback, delta-sigma modulation, and control signaling accounting for phase wrap.

FIG. 4 is a flow diagram of an exemplary method for control signaling in a communication system.

FIG. 5 is a flow diagram of a further exemplary method for control signaling in a communication system.

FIG. 6 illustrates another apparatus for control signaling in a communication system.

FIG. 7 illustrates yet another apparatus for control signaling in a communication system.

### DETAILED DESCRIPTION

The presently disclosed apparatus and methods serve to enhance the performance of mobile wireless communication systems and OTA resource utilization by improving the effectiveness of continuous-valued control signaling for closed-loop operations, including but not limited to CL-TD, in both uplink (UL) and downlink (DL) directions.

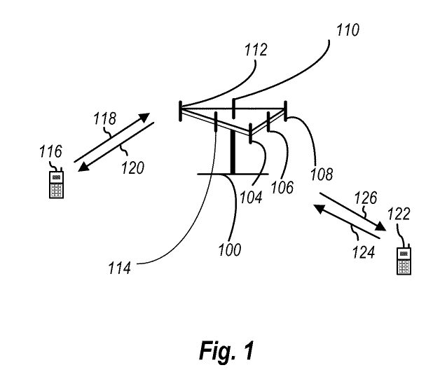

Referring to FIG. 1, a multiple access wireless communication system according to an example is illustrated. An access point (AP) or base station 100 includes multiple antenna groups, one including 104 and 106, another including 108 and 110, and still another including 112 and 114. In FIG. 1, only two antennas are shown for each antenna group, however, more or fewer antennas may be utilized for each antenna group. A mobile device or access terminal 116 (AT) is in communication with antennas 112 and 114, where antennas 112 and 114 transmit information to access terminal 116 over a downlink (DL) or forward link (FL) 120 and receive information from access terminal 116 over an uplink (UL) or reverse link 118. Access terminal 122 is in communication with antennas 106 and 108, where antennas 106 and 108 transmit information to access terminal 122 over DL or forward link 126 and receive information from access terminal 122 over UL or reverse link 124. In a FDD system, communication links 118, 120, 124 and 126 may use different frequency for communication. For example, forward link 120 may use a different frequency than that used by UL or reverse link 118.

Each group of antennas and/or the area in which they are designed to communicate is often referred to as a sector of the access point. In the example, antenna groups each are designed to communicate to access terminals in a sector of the areas covered by access point 100.

In communication over forward links (or downlinks) 120 and 126, the transmitting antennas of base station or access point 100 may utilize beamforming in order to improve the signal-to-noise ratio of forward links for the different access terminals 116 and 122. In addition, a base station or an access point using beamforming to transmit to access terminals scattered randomly through its coverage causes less interference to access terminals in neighboring cells than an access point transmitting through a single antenna to all its access terminals.

An access point may be a fixed or base station used for communicating with the terminals and may also be referred to as an access point, a Node B, or some other terminology. An access terminal may also be called an access terminal, user equipment (UE), a wireless communication device, terminal, access terminal or some other terminology. Additionally, the system in FIG. 1 may be a MIMO system employing multiple (NT) transmit antennas and multiple (NR) receive antennas for data transmission. A MIMO channel formed by the NT transmit and NR receive antennas may be decomposed into NS independent channels, which are also referred to as spatial channels. Each of the NS independent channels corresponds to a dimension. The MIMO system can provide improved performance (e.g., higher throughput and/or greater reliability) if the additional dimensionalities created by the multiple transmit and receive antennas are utilized.

It is noted that the system of FIG. 1 may employ continuous-valued measurement and feedback, such as closed-loop transmit diversity, as an example. In a particular example, a mobile device (e.g., 116 or 122) may receive control feedback from a base station (e.g., 100) in continuous-valued control signaling in a closed-loop for control of phase or power, as merely two examples. As discussed previously, performance degradation of closed-loop transmit diversity (CL-TD), for example, results from necessary quantization due to limited availability of over-the-air (OTA) resources.

Accordingly, the presently disclosed methods and apparatus serve to enhance mobile wireless communication systems performance and/or OTA resource utilization by improving the effectiveness of continuous-valued control signaling for closed-loop operations, including but not limited to CL-TD, in both DL and UL without requiring additional signaling overhead and receiver-transmitter coordination. To achieve this improvement, a delta-sigma (Δ-Σ) approach is utilized. This approach solves the fundamental problem of direct quantization for CL-TD phase feedback, by allowing the feedback channel to be used much more efficiently. Based on an assumption that CL-TD allocated feedback channel bandwidth can often be significantly higher than actualphase control signal bandwidth, a delta-sigma scheme allows CL-TD to exchange excess bandwidth for bit width.

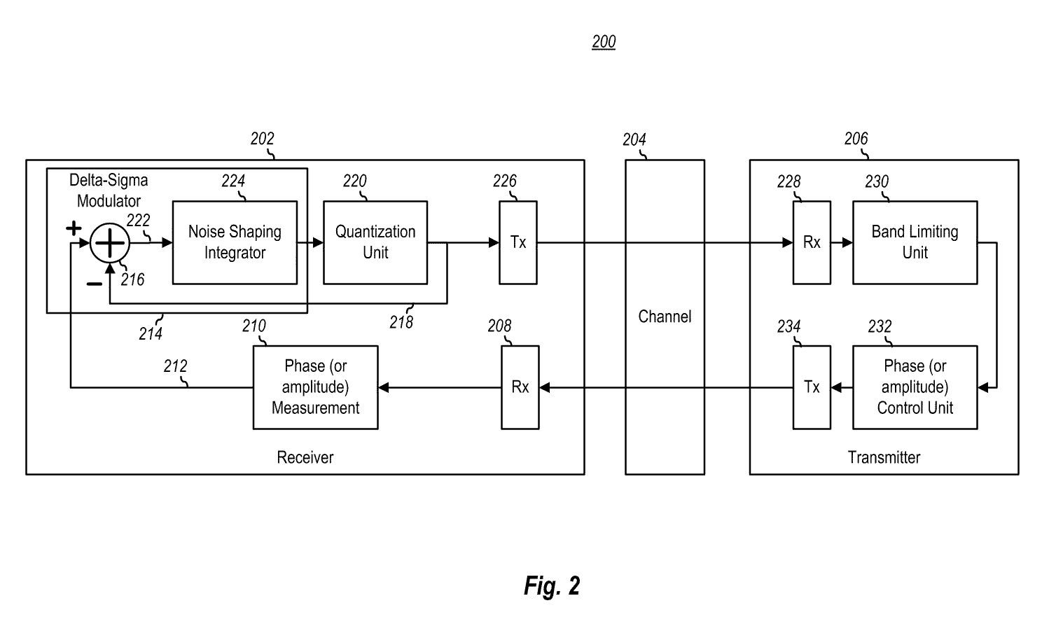

FIG. 2 is a block diagram of an exemplary architecture for a system for CL-TD phase control using feedback, delta-sigma modulation, and control signaling. It is noted that the system 200, although shown in the context of an exemplary phase control, may also be applicable for other control, such as signal amplitude control. As illustrated, the system 200 includes a receiver 202, a channel 204 over which control signaling and feedback are transmitted, and a transmitter 206. It is noted that the receiver 202 may be located in either a base station or a mobile device, and transmitter 206 respectively located in either a mobile device or base station. For purposes of the present example of FIG. 2, it is assumed that receiver 202 is located in base station and transmitter 206 is located in a mobile device.

Receiver 202 includes a receive unit 208 that receives a signal over the channel 202. Block 208 feeds the signal to a phase measurement unit 210 configured to measure the phase of the incoming signal and output a current phase measurement 212. The signal may include pilot tones or symbols that may be used by unit 210 to measure the phase of the incoming signal.

The current phase measurement 212 is input to a delta-sigma modulator 214. Both a difference calculation and an integration are performed within the delta-sigma modulator. Regarding the difference calculation, additive calculation unit 216 receives the current phase measurement 212 and subtracts a previously quantized integrated difference signal 218 (or, stated another way, adds the negative of the quantized integrated difference signal) that is fed back (i.e., a negative feedback loop input) from the output of a quantization unit 220 to achieve a difference signal 222. Thus, delta-sigma modulator 214 includes at least unit 216, integrator 224, and the feedback input 218 from quantization unit 220. It is noted that the quantized integrated difference signal 218 may be converted from the digital signal output by quantization unit 220 to an analog signal, or from the digital signal to another digital signal prior to subtraction from the current measured phase dependent on whether the delta-sigma modulator 214 is configured as a digital or analog modulator (of which both are contemplated by the present disclosure).

Difference signal 222 is input to the integration portion of the delta-sigma modulator 214, illustrated by noise shaping integrator 224, which performs an integration of the difference signal 222 as well as noise shaping. In an aspect, the noise is shaped to an upper band, and integrator function is akin to a filter, such as low pass filter, or other suitable processes for shaping the noise. It is noted that the delta-sigma modulator 214 may be configured as a first order modulator as illustrated by FIG. 1, but one skilled in the art will appreciate that second or higher order delta-sigma modulation could also be employed.

The integrated output of noise shaping integrator 224 is input to the quantization unit 220 to quantize the integrated signal. In an aspect, the quantization may be 2 bit/sample quantization, but one skilled in the art will appreciate that the quantization may be less (i.e., 1 bit quantization) or more (i.e., greater than 2 bit quantization). The quantized output (i.e., the quantized integrated signal) for phase control (e.g., 2 bit) is input to a transmission unit 226 for transmission over the channel 204, and in particular over control or OTA channels to transmitter 206. The quantized signal output by unit 220 is the feedback portion of system 200 providing feedback signaling to the transmitter 206 to enable phase adjustment or control by the transmitter 206.

The delta-sigma modulator 214 with negative feedback from quantization unit 220 maintains the average number of digital bit values at the output equal to the phase measurement signal's percentage of full scale. This is otherwise known in the art as pulse density modulation (PDM). This delta-sigma modulation technique serves to shape the conversion noise of modulator 214 to a high input-sample frequency band, which is away from the frequency band of interest in which the phase control signal resides.

A receiver unit 228 receives the phase control signal over channel 204 and inputs the signal to a filtering or band limiting unit 230. Since delta-sigma modulation is used in formation of the signal, there is a higher level of phase quantization noise resulting from this type of modulation. This noise is removable by simple band limiting (e.g., a low pass filter) with band limiting unit 230, as the noise is in the high input-sample frequency band, which is away from the frequency band of interest in which the phase control signal resides. The result of band limiting in unit 230 is therefore the intended phase control signal is much less correlated with the noise, and may then be input to a phase control unit 232 to control the phase of transmission of a transmit unit 234, which transmits signals to the receiver 202 over channel 204. This completes the closed-loop, feedback system illustrated by FIG. 2.

It is noted that in an aspect, the band limiting unit 230 may be configured to feature dynamic adjustment of the bandwidth (i.e., a variable bandwidth), rather than merely a set bandwidth. Dynamic adjustment can be configured to vary the filter bandwidth of unit 230 based on detection of changes in the channel. For example, if the changes in the channel 204 are slower, such as in the case of a simple repeating pattern, the channel is likely not changing and the bandwidth of unit 230 could be clamped down to a lower bandwidth to eliminate noise (e.g., taking an average or the DC level of the signal). Conversely, in cases of faster changing channel conditions, the bandwidth of unit 230 could be expanded dependent on how fast channel conditions are changing. Dynamic adjustment of the bandwidth of unit 230 would allow better optimization of the performance of the closed loop system.

By employing delta-sigma modulation in the system of FIG. 2, the control signal or OTA bandwidth is more efficiently utilized. In particular, the delta-sigma modulator operates at a high sample ratethereby obtaining a higher resolution result than lower sample rates. This higher resolution and, thus higher utilization of the OTA bandwidth, affords a greater degree of transmit phase control by the phase control unit 232, which improves reception. Additionally, the higher level of phase quantization noise resulting from delta-sigma modulation is shaped mostly in upper frequency bands, and is removable by simple band limiting by band limiting unit 230, and thus uncorrelated from the intended phase signal used by phase control unit 232 to control the phase for transmitted signals.

The proposed delta-sigma modulation of CL-TD control signaling is applicable to not only phase control, but power or amplitude control as well. Thus, in an example of power or amplitude control, the phase control, phase measurement and phase quantization units, could be substituted with amplitude control, measurement, and quantization functionalities. It is further noted that other values beyond merely phase or amplitude control are also contemplated as the apparatus and methodologies disclosed herein are applicable to any control aspects that may be implemented or availed with continuous-valued measurement and feedback.

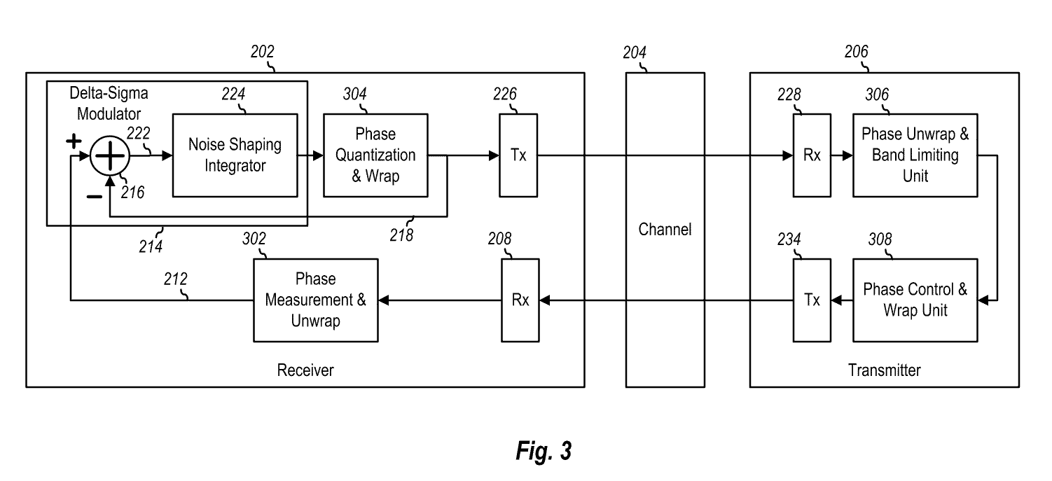

It is noted that some systems may develop a slight complication with phase measurement given 360° (2π radians) periodicity. In particular, phase measurements may exhibit fast artificial transition near 0° and 360° because of wrap-around. This is not an issue for direct quantization, which treats phase measurements individually. Delta-sigma modulation, however, looks at a sequence of phase measurements for efficient utilization of control channel. Thus, in the present system, it may be desirable not to include artificial transition of phase measurement signal. Accordingly, in another aspect, the system of FIG. 2 is illustrated in FIG. 3 to further include functionality for unwrapping of phase measurements before performing delta-sigma modulation at the receiver 202. In particular, the phase measurement unit may further include unwrapping as shown by unit 302. Furthermore, the quantization unit may include the functionality wrapping of quantized value in order to be sent from receiver 202 to transmitter 206, as indicated by unit 304.

At the transmitter 206, the received phase feedback (i.e., the quantized integrated difference signal) may be unwrapped before performing band limiting at the transmitter 206, as indicated by unit 306. Finally, system 200 may include wrapping of the actual phase control within the 360° range prior to transmission of signals by transmit unit 232. This wrapping is performed by unit 308. The signals received at receiver 202 are then unwrapped by the phase measurement and unwrap unit 302.

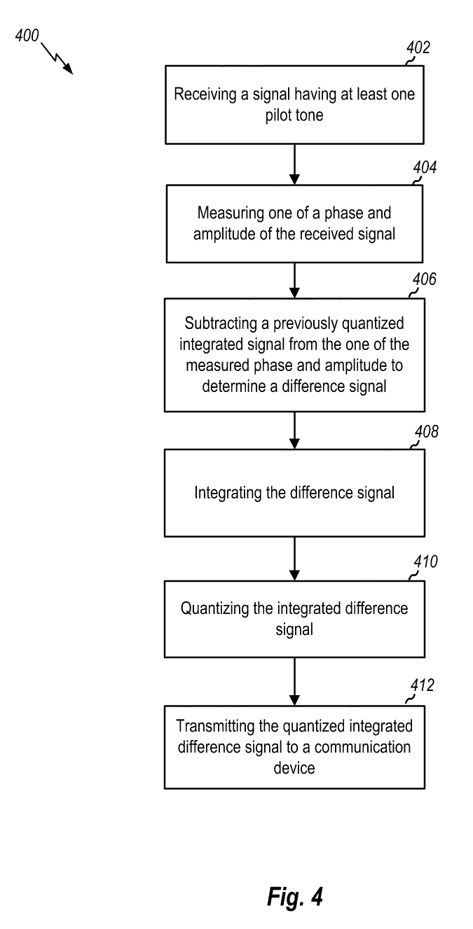

FIG. 4 illustrates a methodology 400 for controlling signaling in a communication system, such as in the systems of FIGS. 1 and 2. Method 400 includes receiving a signal, which may have at least one pilot tone as shown in block 402. This function may be implemented by receive block 208, as an example. The phase or amplitude of this received signal is then measured as shown in block 404. In the example of phase measurement, the process of block 404 may be implemented by phase measurement block 210 in the example of FIG. 2. Alternatively, in the case of amplitude measurement, a similarly configured unit as block 210 could be used to measure amplitude in the method 400. According to another aspect, the process of block 404 may also include unwrapping the signal to account for the periodicity of the signal. Unit 302 in the example of FIG. 3 may implement such process.

After the phase or amplitude are measured, a process in block 406 involves determining a difference signal by subtracting a previously quantized integrated signal from the one of the measured phase and amplitude to determine a difference signal. This process in block 406 may be implemented, for example, by additive block 216 in the example of FIG. 2, which is configured to subtract the fed back quantized integrated signal 218 from phase quantization block 220 from the current phase measurement from phase measurement block 210. The difference signal is output by block 216.

After determination of the difference signal, this signal is then integrated as shown by block 408. The process of block 408 may also include noise shaping of the difference signal to filter out noise, for example. Noise shaping integrator 224 may implement these processes in block 408, for example. Furthermore, it is noted that the processes of block 406 and 408 effect delta-sigma modulation of the phase or amplitude measurement.

After block 408, flow proceeds to block 410 where the integrated difference signal is quantized. Quantization may be performed, as an example, by phase quantization block 220 in the example of FIG. 2. In an alternative, block 410 may also include the process of wrapping the quantized integrated difference signal, and implemented by a unit such as unit 304 in FIG. 3. As indicated in block 412, the quantized integrated difference signal is then transmitted to a communication device, such as transmitter 206 as merely an example from the exemplary system of FIG. 2. Transmission of the quantized integrated difference signal may be effected by transmission block 226, as an example.

The method 400 is repeated continuously to provide a continuous control feedback signal (i.e., the quantized integrated difference signal) to another communication device to be used for phase or amplitude control, as two examples. It is noted that method 400 may be utilized in both uplink and downlink directions for sending feedback information to another wireless device.

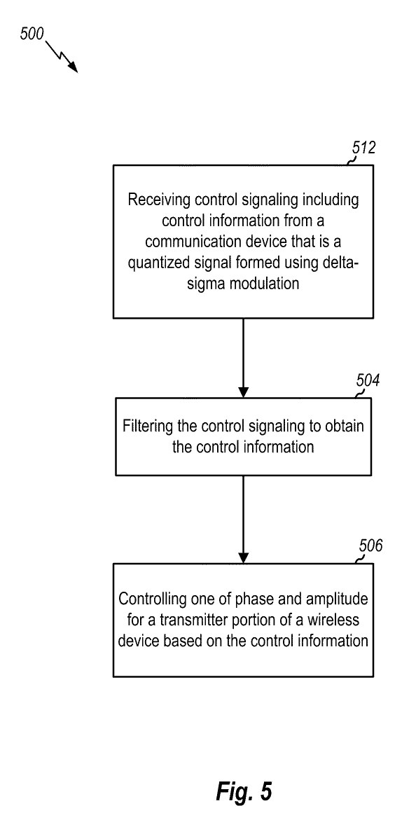

FIG. 5 illustrates another method 500 for controlling signaling in a communication system, such as in the systems of FIGS. 1 and 2. In particular, method 500 effects the receipt of control feedback information in a communication device, which is in turn used to control variables such as phase or amplitude for transmission of signals from the device. The control feedback information is formed by another device utilizing delta-sigma modulation.

Method 500 includes a first block 502 including a process of receiving a control signaling including control information from a communication device that is a quantized signal formed using delta-sigma modulation. This process may be implemented by receive block 228 shown in FIG. 2, as an example, which receives control signaling over a channel (e.g., 204) from a device (e.g., 202) employing delta-sigma modulation for control information, such as phase or amplitude control.

After receipt of the control signaling, the signaling is filtered to obtain the control information as shown in block 504. In an aspect, the filtering is low pass filtering to remove noise resultant from delta-sigma modulation in the upper frequency bands from the desired control information in lower frequency. The process of block 504 is implementable by a device such as band limiting unit 230 shown in FIG. 2. In an alternative, block 504 may further include unwrapping of the control signaling, and implemented by a unit such as unit 306 in the example of FIG. 3.

Once the control information has been obtained, a next block 506 illustrates controlling one of phase and amplitude for a transmit portion of a wireless device based on the control information. This process of block 506 may be effected by phase control unit 232, which provides control of certain aspects of transmit portion 234, as an example from FIG. 2. Block 506 may also include the process of wrapping the signal to be transmitted as discussed previously in connection with block 308 in FIG. 3.

It will be appreciated by those skilled in the art that the method 500 may be carried out for either an uplink or a downlink in either in a base station or a mobile device. The salient application of method 500, however, is at reception end of a feedback control link for controlling aspects of transmission in the reverse direction, as in a CL-TD system.

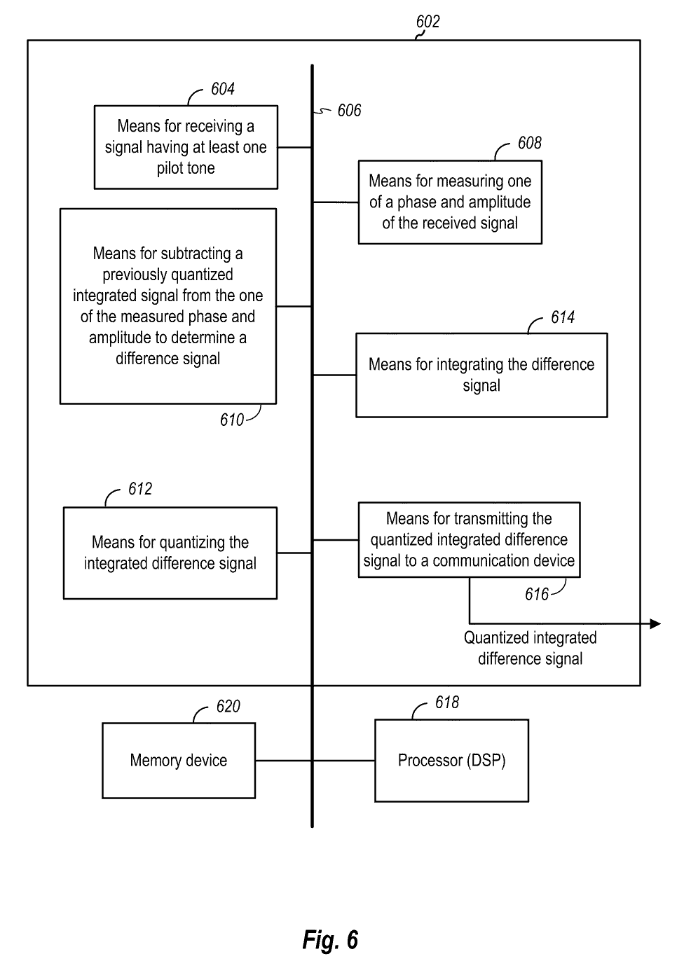

FIG. 6 illustrates an apparatus 602 for control signaling in a communication system. Apparatus 602 includes means 604 for receiving a signal, which may have at least one pilot tone as shown in block. It is noted that means 604 may be implemented by receive block 208 of FIG. 2, as one example, or equivalent receiver circuits. The signal received by means 604 may then be communicated to various other modules in apparatus 602 via a bus 606, or similarly suitable communication coupling or interface.

In particular, means 602 communicates the received signal to a means 608 for measuring phase or amplitude of the received signal. In the example of phase measurement, means 608 may be implemented by phase measurement block 210 in the example of FIG. 2, or an equivalent measurement device configured to measure phase or amplitude. Alternatively, in the case of amplitude measurement, means 608 may be similarly configured unit as block 210 that measures amplitude. Furthermore, means 608 may be further configured to unwrap the received signal, and implemented with a unit such as unit 302 in FIG. 3.

Means 608 sends the phase or amplitude measurement to a means 610 for determining a difference signal by subtracting a previously quantized integrated signal from the one of the measured phase and amplitude to determine a difference signal. Means 610 may be implemented, for example, by additive block 216 in the example of FIG. 2, which is configured to subtract the fed back quantized integrated signal 218 from phase quantization block 220 from the current phase measurement from phase measurement block 210. In the particular example of FIG. 6, it is noted that the previously quantized integrated signal is obtained from a means for quantizing 612, which will be discussed below and may be implemented by phase quantization block 220 or 304 shown in FIGS. 2 and 3.

After determination of the difference signal, this difference signal is then integrated by means for integrating the difference signal 614. Means 614 may also include noise shaping of the difference signal to filter out noise, for example. Means 614 may be implemented by noise shaping integrator 224, for example, or equivalent functional circuit to integrate a signal. Furthermore, it is noted that the combination of means 610 and 614 effect delta-sigma modulation of the phase or amplitude measurement.

Apparatus 602 also includes the means 612 for quantization, which quantizes the integrated difference signal determined by means 614. Means 612 may be implemented, as an example, by phase quantization block 220 in the example of FIG. 2 or block 304 in FIG. 3, which includes an alternate aspect of phase wrapping. A means 616 for transmitting the quantized integrated difference signal to a communication device, such as transmitter 206 as merely an example from the exemplary system of FIG. 2. Transmission of the quantized integrated difference signal may be effected by transmission block 226, as an example.

Additionally, it is noted that apparatus 602 may also be in communication with a processor 618, such as a DSP, which among other things reads and/or writes one or more programmable instructions (or program code) to a memory device 620. Processor 618 and memory 620 may be in communication with the other means or modules within apparatus 602 as indicated by coupling to bus 606. It is noted that the present apparatus may be implemented in hardware, software, firmware, or any combinations thereof. It will also be appreciated by those skilled in the art that apparatus 602 may be used for either uplink or downlink feedback control signaling in either in a base station or a mobile device.

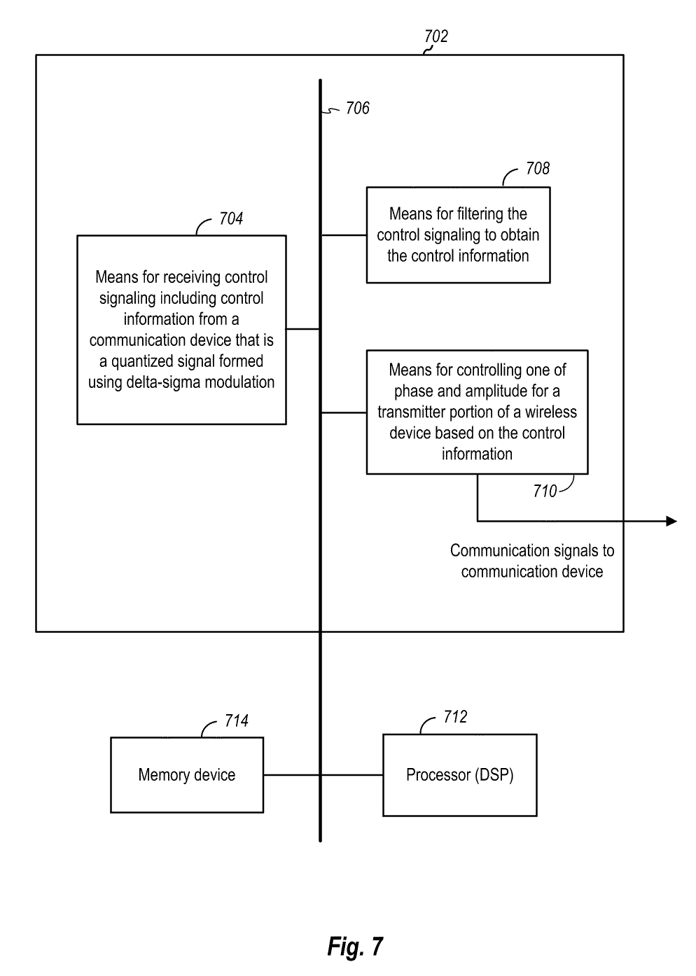

FIG. 7 illustrates another apparatus 702 for control signaling in a communication system that effects the receipt of control feedback information in a communication device, which is in turn used to control variables such as phase or amplitude for transmission of signals from the device. The control feedback information is formed by another communication device utilizing delta-sigma modulation. Apparatus 702 includes a means 704 for receiving a control signaling including control information from a communication device that is a quantized signal formed using delta-sigma modulation. Means 704 may be implemented by receive block 228 shown in FIG. 2, as an example, or equivalently configured receive device that receives control signaling over a channel (e.g., 204) from a device (e.g., 202) employing delta-sigma modulation for control information, such as phase or amplitude control. The signal received by means 704 may then be communicated to various other modules in apparatus 702 via a bus 706, or similarly suitable communication coupling or interface.

The control signaling received by means 704 is then communicated to a means 708, for filtering the control signaling to obtain the control information. In an aspect, means 708 may be configured to employ low pass filtering to remove noise resultant from delta-sigma modulation in the upper frequency bands from the desired control information in lower frequency. Means 708 is implementable by a device such as band limiting unit 230 shown in FIG. 2, or similarly configured band limiting or filtering device. In an alternative, mean 708 may further include unwrapping of the control signaling, and implemented by a unit such as unit 306 in the example of FIG. 3.

Once the control information has been obtained by means 708, this information is passed on to a means 710 for controlling one of phase and amplitude for a transmit portion of a wireless device based on the control information. Means 710 may be effected by phase control unit 232, which provides control of certain aspects of transmit portion 234, as an example from FIG. 2. Means 710 may also include the functionality of wrapping the signal to be transmitted as discussed previously in connection with block 308 in FIG. 3.

Additionally, it is noted that apparatus 702 may also be in communication with a processor 712, such as a DSP, which among other things reads and/or writes one or more programmable instructions to a memory device 714. Processor 712 and memory 714 may be in communication with the other means or modules within apparatus 702 as indicated by coupling to bus 706. It is noted that the present apparatus may be implemented in hardware, software, firmware, or any combinations thereof. It will also be appreciated by those skilled in the art that apparatus 702 may be used for control of either uplink or downlink signaling utilizing received feedback in either in a base station or a mobile device.

As disclosed the present apparatus and methods employing delta-sigma modulation afford CL-TD performance that is not limited by direct quantization resolution considering stationary case with constant phase adjustment from receiver to transmitter not happen to align with any of available phase options. Additionally, CL-TD performance is the present disclosure not limited by capacity of feedback channel considering a stationary case when a receiver (e.g. 202) keeps sending the same phase adjustment command to transmitter (e.g. 206). Of further note, the presently disclosed apparatus and methods afford CL-TD phase feedback signaling that consists of information not only in individual command, but also in sequence of phase adjustment commands.

Moreover, the presently disclosed apparatus and methods engender a signaling approach that allows control precision to not be limited by signaling quantization resolution. Also, the present apparatus and methods allow control accuracy to not be limited by choice of signaling quantization constellation, allow control signaling to be truly effective by fully utilizing control channel capacity, and result in a reduction of the control signaling that is more effective and provides better system performance.

While, for purposes of simplicity of explanation, the disclosed methodologies are shown and described herein as a series or number of acts, it is to be understood that the processes described herein are not limited by the order of acts, as some acts may occur in different orders and/or concurrently with other acts from that shown and described herein. For example, those skilled in the art will appreciate that a methodology could alternatively be represented as a series of interrelated states or events, such as in a state diagram. Moreover, not all illustrated acts may be required to implement a methodology in accordance with the subject methodologies disclosed herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The word “exemplary” as used herein is intended to mean “serving as an example, instance, or illustration.” Any example described herein as “exemplary” is not necessarily to be construed as preferred or advantageous over other examples.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present disclosure is not intended to be limited to the examples shown herein but is to be accorded the widest scope consistent with the principles and novel features disclosed herein.

What is claimed is:

1. A method for control signaling comprising:
receiving a communication signal;
measuring at least one of a phase and amplitude of the received communication signal to derive a current measurement signal;
determining a difference signal by subtracting a previously quantized integrated difference signal from the current measurement signal;
integrating the difference signal;
quantizing the integrated difference signal; and
transmitting the quantized integrated difference signal as part of control signaling to a communication device.

2. The method as defined in claim 1, wherein determining and integrating the difference signal comprises delta-sigma modulation.

3. The method as defined in claim 1, wherein the communication device is one of a base station and a mobile wireless device.

4. The method as defined in claim 1, wherein the control signaling comprises closed loop, transmit diversity control signaling.

5. The method as defined in claim 1, wherein measuring a phase of the received communication signal includes unwrapping of the received communication signal to account for periodicity of the signal.

6. The method as defined in claim 1, wherein quantizing the integrated difference signal further includes phase wrapping for quantization of phase information.

7. The method as defined in claim 1, wherein quantizing the integrated difference signal utilizes 2 bits per sample quantization.

8. The method as defined in claim 1, wherein integrating the difference signal includes noise shaping of the difference signal.

9. A method for control signaling comprising:
receiving control signaling including control information from a communication device that is a quantized signal formed using delta-sigma modulation;
filtering the control signaling to obtain the control information; and
controlling one of phase and amplitude for a transmitter portion of a wireless device based on the control information.

10. The method as defined in claim 9, wherein the communication device is one of a base station and a mobile wireless device.

11. The method as defined in claim 9, wherein the control signaling comprises closed loop, transmit diversity control signaling.

12. The method as defined in claim 9, wherein filtering the control signaling further comprises low pass filtering of the control signaling to obtain the control information.

13. The method as defined in claim 9, wherein filtering the control signaling further comprises phase unwrapping of the received control signaling to account for periodicity of the signaling.

14. The method as defined in claim 9, wherein controlling one of phase and amplitude for a transmitter portion of a wireless device based on the control information includes phase wrapping of signals to be transmitted by the transmitter portion.

15. An apparatus for control signaling comprising:
a receive unit configured to receive a communication signal;
a measurement unit configured to measure at least one of a phase and amplitude of the received communication signal to derive a current measurement signal;
an additive calculation unit configured to determine a difference signal by subtracting a previously quantized integrated difference signal from the current measurement signal;
an integrator configured to integrate the difference signal;
a quantization unit configured to quantize the integrated difference signal; and
a transmitter unit configured to transmit the quantized integrated difference signal as part of control signaling to a communication device.

16. The apparatus as defined in claim 15, further comprising a delta-sigma modulation unit including at least the additive calculation unit, the integrator, and a feedback input from the quantization unit.

17. The apparatus as defined in claim 15, wherein the communication device is one of a base station and a mobile wireless device.

18. The apparatus as defined in claim 15, wherein the control signaling comprises closed loop, transmit diversity control signaling.

19. The apparatus as defined in claim 15, wherein measurement unit configured to measuring a phase of the received communication signal is further configured to unwrap the received communication signal to account for periodicity of the signal.

20. The apparatus as defined in claim 15, wherein the quantization unit is further configured to phase wrap for quantization of phase information.

21. The apparatus as defined in claim 15, wherein quantization unit is configured to quantize the integrated difference signal using 2 bits per sample quantization.

22. The apparatus as defined in claim 15, wherein the integrator is further configured to noise shape the difference signal.

23. An apparatus for control signaling comprising:
a receiver unit configured to receive control signaling including control information from a communication device that is a quantized signal formed using delta-sigma modulation;
a band limiting unit configured to filter the control signaling to obtain the control information; and
a control unit configured to control one of phase and amplitude for a transmitter portion of a wireless device based on the control information.

24. The apparatus as defined in claim 23, wherein the communication device is one of a base station and a mobile wireless device.

25. The apparatus as defined in claim 23, wherein the wireless device is one of a base station and a mobile wireless device.

26. The apparatus as defined in claim 23, wherein the control signaling comprises closed loop, transmit diversity control signaling.

27. The apparatus as defined in claim 23, wherein the band limiting unit is further configured to low pass filter the control signaling to obtain the control information.

28. The apparatus as defined in claim 23, wherein the band limiting unit is further configured to phase unwrap the received control signaling to account for periodicity of the signaling.

29. The apparatus as defined in claim 23, wherein the control unit is further configured to phase wrap signals to be transmitted by the transmitter portion.

30. An apparatus for control signaling comprising:
means for receiving a communication signal;
means for measuring at least one of a phase and amplitude of the received communication signal to derive a current measurement signal;
means for determining a difference signal by subtracting a previously quantized integrated difference signal from the current measurement signal;
means for integrating the difference signal;
means for quantizing the integrated difference signal; and
means for transmitting the quantized integrated difference signal as part of control signaling to a communication device.

31. The apparatus as defined in claim 30, wherein the means for determining and for integrating the difference signal comprise a means for delta-sigma modulation.

32. The apparatus as defined in claim 30, wherein the communication device is one of a base station and a mobile wireless device.

33. The apparatus as defined in claim 30, wherein the control signaling comprises closed loop, transmit diversity control signaling.

34. The apparatus as defined in claim 30, wherein the means for measuring a phase of the received communication signal includes means for unwrapping of the received communication signal to account for periodicity of the signal.

35. The apparatus as defined in claim 30, wherein the means for quantizing the integrated difference signal further includes means for phase wrapping for quantization of phase information.

36. The apparatus as defined in claim 30, wherein the means for quantizing the integrated difference signal utilizes 2 bits per sample quantization.

37. The apparatus as defined in claim 30, wherein the means for integrating the difference signal includes means for noise shaping of the difference signal.

38. An apparatus for control signaling comprising:
means for receiving control signaling including control information from a communication device that is a quantized signal formed using delta-sigma modulation;
means for filtering the control signaling to obtain the control information; and
means for controlling one of phase and amplitude for a transmitter portion of a wireless device based on the control information.

39. The apparatus as defined in claim 38, wherein the communication device is one of a base station and a mobile wireless device, and the wireless device is correspondingly a mobile wireless device or a base station.

40. The apparatus as defined in claim 38, wherein the control signaling comprises closed loop, transmit diversity control signaling.

41. The apparatus as defined in claim 38, wherein the means for filtering the control signaling further comprises means for low pass filtering of the control signaling to obtain the control information.

42. The apparatus as defined in claim 38, wherein means for filtering the control signaling further comprises means for phase unwrapping of the received control signaling to account for periodicity of the signaling.

43. The apparatus as defined in claim 38, wherein the means for controlling one of phase and amplitude for a transmitter portion of a wireless device based on the control information includes means for phase wrapping of signals transmitted by the transmitter portion.

44. A computer program product, comprising:
computer-readable medium comprising:
code for causing a computer to receive a communication signal;
code for causing a computer to measure at least one of a phase and amplitude of the received communication signal to derive a current measurement signal;
code for causing a computer to determine a difference signal by subtracting a previously quantized integrated difference signal from the current measurement signal;
code for causing a computer to integrate the difference signal;
code for causing a computer to quantize the integrated difference signal; and
code for causing a computer to transmit the quantized integrated difference signal as part of control signaling to a communication device.

45. The computer program product as defined in claim 44, wherein determining and integrating the difference signal comprises delta-sigma modulation.

46. The computer program product as defined in claim 44, wherein the communication device is one of a base station and a mobile wireless device.

47. The computer program product as defined in claim 44, wherein the control signaling comprises closed loop, transmit diversity control signaling.

48. The computer program product as defined in claim 44, wherein the code for causing a computer to measure a phase of the received communication signal includes code for causing a computer to unwrap the received communication signal to account for periodicity of the signal.

49. The computer program product as defined in claim 44, wherein the code for causing a computer to quantize the integrated difference signal further includes code for causing a computer to phase wrap in quantizing the phase information.

50. The computer program product as defined in claim 44, wherein the code for causing a computer to quantize the integrated difference signal uses 2 bits per sample quantization.

51. The computer program product as defined in claim 44, wherein the code for causing a computer to integrate the difference signal includes code for causing a computer to noise shape the difference signal.

52. A computer program product, comprising:
computer-readable medium comprising:
code for causing a computer to receive control signaling including control information from a communication device that is a quantized signal formed using delta-sigma modulation;
code for causing a computer to filter the control signaling to obtain the control information; and
code for causing a computer to control one of phase and amplitude for a transmitter portion of a wireless device based on the control information.

53. The computer program product as defined in claim 52, wherein the communication device is one of a base station and a mobile wireless device, and the wireless device is correspondingly a mobile wireless device or a base station.

54. The computer program product as defined in claim 52, wherein the control signaling comprises closed loop, transmit diversity control signaling.

55. The computer program product as defined in claim 52, wherein the code for causing a computer to filter the control signaling further comprises code for causing a computer to low pass filter the control signaling to obtain the control information.

56. The computer program product as defined in claim 52, wherein the code for causing a computer to filter the control signaling further comprises code for causing a computer to phase unwrap the received control signaling to account for periodicity of the signaling.

57. The computer program product as defined in claim 52, wherein the code for causing a computer to control one of phase and amplitude for a transmitter portion of a wireless device based on the control information includes code for causing a computer to phase wrap signals to be transmitted by the transmitter portion.
